(19) United States
(12) Patent Application Publication
(10) Pub. No.: US 2015/0323014 A1
(43) Pub. Date: Nov. 12, 2015

(54) SPLINE PRESS FIT ORIENTATION LEAD IN

(71) Applicant: Steering Solutions IP Holding Corporation, Saginaw, MI (US)

(72) Inventors: Michael W. Clark, Essexville, MI (US); Brandon G. Wynn, Bay City, MI (US); David G. Matousek, Bay City, MI (US)

(73) Assignee: Steering Solutions IP Holding Corporation, Saginaw, MI (US)

(21) Appl. No.: 14/272,991

(22) Filed: May 8, 2014

(51) Int. Cl. F16D 1/06

(52) U.S. Cl. CPC F16D 1/06

(57) ABSTRACT

A shaft coupling assembly includes a male shaft having a splined portion including a plurality of male shaft teeth formed on an outer surface of the male shaft, a lead-in zone formed on at least one tooth of the plurality of male shaft teeth, the lead-in zone including a pair of flank surfaces, a female shaft having a splined portion including a plurality of female shaft teeth formed on an inner surface of the female shaft, and a first flank surface and a second flank surface formed on adjacent female shaft teeth of the plurality of female teeth. The first flank surface and the second flank surface are stepped from each other such that a first distance between first flank surfaces of the adjacent female shaft teeth is greater than a second distance between second flank surfaces of the adjacent female shaft teeth.

### BACKGROUND OF THE INVENTION

The present disclosure relates to splined couplings for two components and, more particularly, to splined couplings having lead-ins for aligning two components before a press-fitting operation.

Some steering column assemblies include an upper steering shaft coupled to a lower steering shaft. The upper and lower steering shafts rotate together to transfer rotational movement from a vehicle steering wheel to the vehicle road wheels. To couple the upper and lower shafts, the shafts may include splined portions, which are press fit together to achieve the desired coupling. However, precise location in a press machine is typically required to align the shafts before they are press fit together, which may be time consuming and require expensive machinery.

Accordingly, it is desirable to provide a splined connection that can be easily aligned without alignment fixtures or machines.

### SUMMARY OF THE INVENTION

In an embodiment of the invention, an alignment and lead-in shaft coupling assembly is provided. The shaft coupling assembly includes a male shaft having a splined portion including a plurality of male shaft teeth formed on an outer surface of the male shaft, and a lead-in zone formed on at least one tooth of the plurality of male shaft teeth, the lead-in zone including a pair of flank surfaces. The assembly further includes a female shaft having a splined portion including a plurality of female shaft teeth formed on an inner surface of the female shaft, and a first flank surface and a second flank surface formed on adjacent female shaft teeth of the plurality of female teeth. The first flank surface and the second flank surface are stepped from each other such that a first distance between first flank surfaces of the adjacent female shaft teeth is greater than a second distance between second flank surfaces of the adjacent female shaft teeth. The first distance is greater than a third distance between the lead-in zone flank surfaces such that the lead in zone is configured for insertion between the first flank surfaces of the adjacent female shaft teeth without interference therebetween.

In another embodiment of the invention, a steering column shaft assembly for a vehicle is provided. The shaft assembly includes a male shaft having a splined portion including a plurality of male shaft teeth formed on an outer surface of the male shaft, and a lead-in zone formed on at least one tooth of the plurality of male shaft teeth, the lead-in zone including a pair of flank surfaces. The shaft assembly further includes a female shaft having a splined portion including a plurality of female shaft teeth formed on an inner surface of the female shaft, and a first flank surface and a second flank surface formed on adjacent female shaft teeth of the plurality of female teeth. The first flank surface and the second flank surface are stepped from each other such that a first distance between first flank surfaces of the adjacent female shaft teeth is greater than a second distance between second flank surfaces of the adjacent female shaft teeth. The first distance is greater than a third distance between the lead-in zone flank surfaces such that the lead in zone is configured for insertion between the first flank surfaces of the adjacent female shaft teeth without interference therebetween.

In yet another embodiment of the invention, a method of fabricating an alignment and lead-in shaft coupling assembly is provided. The method includes providing a male shaft, forming a splined portion on the male shaft, the splined portion including a plurality of male shaft teeth formed on an outer surface of the male shaft, and forming a lead-in zone on at least one tooth of the plurality of male shaft teeth, the lead-on zone including a pair of flank surfaces. The method further includes providing a female shaft, forming a splined portion on the female shaft, the splined portion including a plurality of female shaft teeth formed on an inner surface of the female shaft, and forming a first flank surface and a second flank surface on adjacent female shaft teeth of the plurality of female shaft teeth. The first flank surface and the second flank surface are stepped from each other such that a first distance between first flank surfaces of the adjacent female shaft teeth is greater than a second distance between second flank surfaces of the adjacent female shaft teeth. The first distance is greater than a third distance between the lead-in zone flank surfaces such that the lead in zone is configured for insertion between the first flank surfaces of the adjacent female shaft teeth without interference therebetween.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary splined coupling between two shafts;

FIG. 2 is an enlarged view of the splined coupling shown in FIG. 1; and

FIG. 3 is a cross-sectional view of a portion of the splined coupling shown in FIGS. 1 and 2.

### DETAILED DESCRIPTION

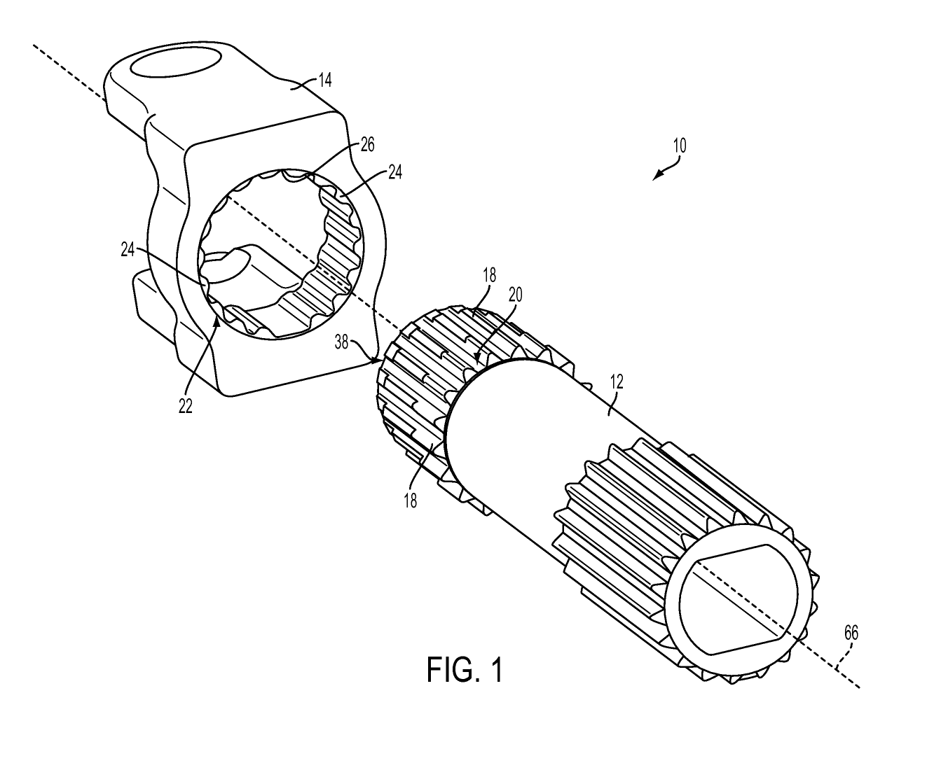

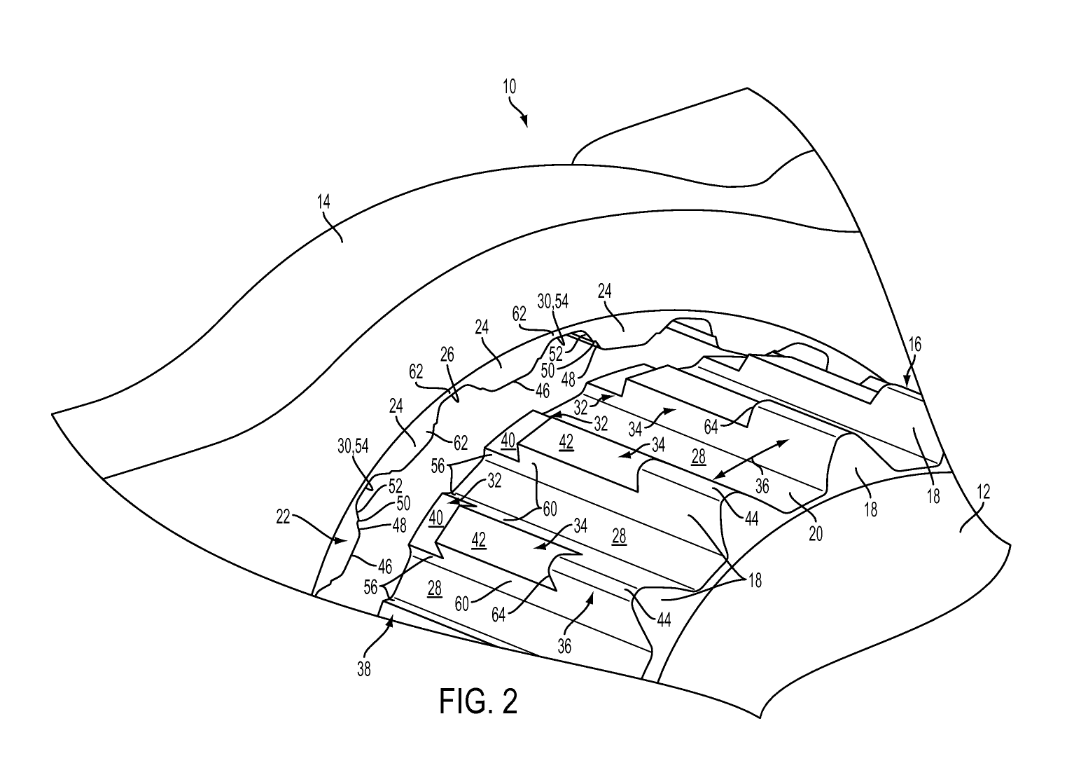

Referring now to the Figures, where the invention will be described with reference to specific embodiments, without limiting same, FIGS. 1 and 2 illustrate a steering column shaft assembly 10 that generally includes a male shaft 12 and a female shaft 14. Steering column shaft assembly 10 enables an operator of a vehicle to control the direction of the vehicle through manipulation of a hand wheel (not shown) coupled to shaft assembly 10, which is mechanically connected to the vehicle road wheels (not shown). Although described as steering column shafts 12, 14, male shaft 12 and female shaft 14 may be any type of shafts configured for coupling to each other.

As shown in FIGS. 1-3, male shaft 12 includes a splined portion 16 having a plurality of male teeth 18 spaced circumferentially about an outer surface 20 of shaft 12. Female shaft 14 includes a splined portion 22 having a plurality of female teeth 24 spaced circumferentially about an inner surface 26 of shaft 14. On male shaft 12, lands 28 are formed circumferentially about outer surface 20 between each pair of teeth 18, and lands 28 are configured to engage female teeth 24. On female shaft 14, lands 30 are formed circumferentially about inner surface 26 between each pair of teeth 24.

Each male tooth 18 includes a lead-in zone 32, a press-fit zone 34, and a full tooth form fit zone 36. Lead-in zone 32 is formed adjacent a shaft end 38 and includes a flat surface 40 extending above surface 20 and lands 28. Press-fit zone 34 includes a flat surface 42 that is stepped-up from and extends above lead-in zone flat surface 40. Full tooth form zone 36 includes a rounded tooth surface 44 that is stepped-up from and extends above press-fit zone flat surface 42.

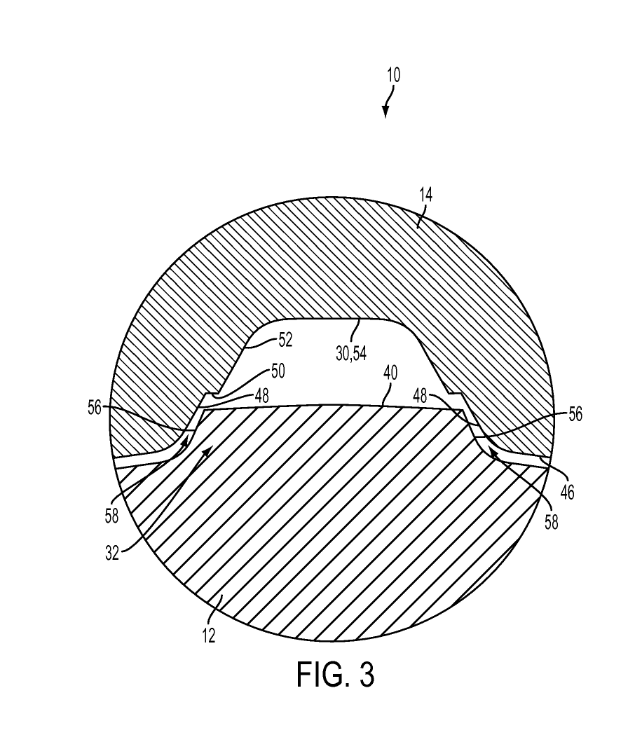

Each female tooth 24 includes an outer diameter surface 46, a first flank surface 48, a clearance diameter surface 50, and a second flank surface 52. Lands 30 between adjacent teeth 24 define an inner diameter surface 54. First flank surface 48 is configured to be oriented adjacent a flank surface 56 of lead-in zone 32 such that a clearance 58 is defined between male shaft flank surfaces 56 and first flank surfaces 48 (see FIG. 3). Second flank surface 52 is configured to interferingly engage a flank surface 60 of press-fit zone 34, and a clearance (not shown) is defined between inner diameter surface 54 and flat surface 42.

Female splined portion 22 includes a stop surface 62 configured to engage a forward surface 64 of full tooth form zone 36 to provide a press limit against forward surface 64. As such, engagement between stop surface 62 and forward surface 64 facilitates preventing further insertion of male shaft 12 into female shaft 14 during a press-fitting operation.

Male shaft 12 and female shaft 14 are coupled to each other by meshing of male teeth 18 and female teeth 24 with each other by axial press-fitting along an axial direction 66 (FIG. 1) of shafts 12, 14. Accordingly, during assembly, each flat surface 40 of the plurality of male shaft lead-in zones 32 is aligned between corresponding female teeth 24 such that lead-in zone flank surfaces 56 of each tooth 18 are positioned between first flank surfaces 48 of adjacent female teeth 24 (see FIG. 3). The clearance area 58 defined between each flank surface 48 and flank surface 56 enables the lead-in zone 32 of male shaft end 38 to be inserted into female shaft 14 by hand without the use of any specialized equipment (e.g., alignment machinery).

After male teeth lead-in zones 34 are inserted between female teeth flank surfaces 48, shafts 12, 14 are then placed in a press machine (not shown). Shafts 12, 14 are then axially press-fitted along axial direction 66 such that flank surfaces 60 of each press-fit zone 34 frictionally engage second flank surfaces 52 of adjacent female teeth 24 until male spline forward surfaces 64 reach stop surface 62 on female shaft splined portion 22.

A method of fabricating splined shafts includes providing male shaft 12 with splined portion 16 formed thereon. Splined portion 16 is formed with teeth 18 having stepped surfaces 40, 42, 44 that define lead-in zone 32, press-fit zone 34, and full tooth form zone 36, respectively. Female shaft 14 is provided with splined portion 22 formed thereon. Splined portion 22 is formed with teeth 24 each having outer diameter surface 46 and stepped flank surfaces 48, 52. Splined portion 22 is also formed such that clearance area 58 is defined between flank surfaces 48 and flank surfaces 56 to facilitate aligning and coupling shafts 12, 14 before a press-fitting operation.

Described herein are systems and methods for providing lead-in alignment and orientation features for splined, press-fitting shafts. The male shaft is provided with a splined portion having teeth with stepped zones. The female shaft is provided with a splined portion having teeth with stepped flank surfaces. A first zone formed in the male teeth enables the male shaft to be aligned and oriented with one of the stepped flank surfaces of the female teeth without interference therebetween. This enables initial coupling between the two shafts by hand before performing a press-fitting operation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. An alignment and lead-in shaft coupling assembly comprising:
a male shaft having a splined portion including a plurality of male shaft teeth having tooth top surfaces formed on an outer surface of the male shaft;
a lead-in zone formed on at least one tooth of the plurality of male shaft teeth, the lead-in zone including a pair of flank surfaces and a flat surface extending above the outer surface and below the tooth top surface between the flank surfaces of the lead-in zone, the lead-in zone disposed proximate a shaft end;
a female shaft having a splined portion including a plurality of female shaft teeth formed on an inner surface of the female shaft; and
a first flank surface and a second flank surface formed on adjacent female shaft teeth of the plurality of female teeth, the first flank surface and the second flank surface are stepped from each other such that a first distance between first flank surfaces of the adjacent female shaft teeth is greater than a second distance between second flank surfaces of the adjacent female shaft teeth, and the first distance is greater than a third distance between the lead-in zone flank surfaces such that the lead in zone is configured for insertion between the first flank surfaces of the adjacent female shaft teeth without interference therebetween.

2. The shaft coupling assembly of claim 1, further comprising a press-fit zone formed on the at least one tooth of the plurality of male shaft teeth adjacent to the lead-in zone, the press-fit zone including a pair of flank surfaces and a flat surface extending above the outer surface between the flank surfaces of the press-fit zone, wherein the lead-in zone and the press-fit zone are stepped such that the flat surface of the press-fit zone extends radially outward from the male shaft outer surface further than the flat surface of the lead-in zone.

3. The shaft coupling assembly of claim 2, wherein the second distance is less than a fourth distance between the press-fit zone flank surfaces such that the press-fit zone flank surfaces are configured to interferingly engage the second flank surfaces when the male and female shafts are subjected to a press-fitting operation.

4. The shaft coupling assembly of claim 3, wherein the female shaft splined portion includes an inner diameter surface formed between adjacent female shaft teeth.

5. The shaft coupling assembly of claim 4, further comprising a full tooth form zone formed on the at least one tooth of the plurality of male shaft teeth adjacent to the press-fit zone, wherein the press-fit zone and the full tooth form zone are stepped from each other such that the full tooth form zone extends radially outward from the male shaft outer surface further than the press-fit zone.

6. The shaft coupling assembly of claim 5, wherein a forward surface of the full tooth form zone is configured to interferingly engage a stop surface of the female shaft splined portion when the male and female shafts are subjected to the press-fitting operation.

7. A steering column shaft assembly for a vehicle, the steering column shaft assembly comprising:
a male shaft having a splined portion including a plurality of male shaft teeth having tooth top surfaces formed on an outer surface of the male shaft;
a lead-in zone formed on at least one tooth of the plurality of male shaft teeth, the lead-in zone including a pair of flank surfaces and a flat surface extending above the outer surface and below the tooth top surface between the flank surfaces of the lead-in zone, the lead-in zone disposed proximate a shaft end;
a female shaft having a splined portion including a plurality of female shaft teeth formed on an inner surface of the female shaft; and
a first flank surface and a second flank surface formed on adjacent female shaft teeth of the plurality of female teeth, the first flank surface and the second flank surface are stepped from each other such that a first distance between first flank surfaces of the adjacent female shaft teeth is greater than a second distance between second flank surfaces of the adjacent female shaft teeth, and the first distance is greater than a third distance between the lead-in zone flank surfaces such that the lead in zone is configured for insertion between the first flank surfaces of the adjacent female shaft teeth without interference therebetween.

8. The shaft assembly of claim 7, further comprising a press-fit zone formed on the at least one tooth of the plurality of male shaft teeth adjacent to the lead-in zone, the press-fit zone including a pair of flank surfaces and a flat surface extending above the outer surface between the flank surfaces of the press-fit zone, wherein the flat surface of the lead-in zone and the flat surface of the press-fit zone are stepped such that the press-fit zone extends radially outward from the male shaft outer surface further than the lead-in zone.

9. The shaft assembly of claim 8, wherein the second distance is less than a fourth distance between the press-fit zone flank surfaces such that the press-fit zone flank surfaces are configured to interferingly engage the second flank surfaces when the male and female shafts are subjected to a press-fitting operation.

10. The shaft assembly of claim 9, wherein the female shaft splined portion includes an inner diameter surface formed between adjacent female shaft teeth.

11. The shaft assembly of claim 10, further comprising a full tooth form zone formed on the at least one tooth of the plurality of male shaft teeth adjacent to the press-fit zone, wherein the press-fit zone and the full tooth form zone are stepped from each other such that the full tooth form zone extends radially outward from the male shaft outer surface further than the press-fit zone.

12. The shaft assembly of claim 11, wherein a forward surface of the full tooth form zone is configured to interferingly engage a stop surface of the female shaft splined portion when the male and female shafts are subjected to the press-fitting operation.

13. A method of fabricating an alignment and lead-in shaft coupling assembly, the method comprising:
providing a male shaft;
forming a splined portion on the male shaft, the splined portion including a plurality of male shaft teeth having tooth top surfaces formed on an outer surface of the male shaft;
forming a lead-in zone on at least one tooth of the plurality of male shaft teeth, the lead-on zone including a pair of flank surfaces and a flat surface extending above the outer surface and below the tooth top surface between the flank surfaces of the lead-in zone, the lead-in zone disposed proximate a shaft end;
providing a female shaft;
forming a splined portion on the female shaft, the splined portion including a plurality of female shaft teeth formed on an inner surface of the female shaft; and
forming a first flank surface and a second flank surface on adjacent female shaft teeth of the plurality of female shaft teeth, the first flank surface and the second flank surface are stepped from each other such that a first distance between first flank surfaces of the adjacent female shaft teeth is greater than a second distance between second flank surfaces of the adjacent female shaft teeth, and the first distance is greater than a third distance between the lead-in zone flank surfaces such that the lead in zone is configured for insertion between the first flank surfaces of the adjacent female shaft teeth without interference therebetween.

14. The method of claim 13, further comprising forming a press-fit zone on the at least one tooth of the plurality of male shaft teeth adjacent to the lead-in zone, the press-fit zone including a pair of flank surfaces and a flat surface extending above the outer surface between the flank surfaces of the press-fit zone, wherein the flat surface of the lead-in zone and the flat surface of the press-fit zone are stepped from each other such that the press-fit zone extends radially outward from the male shaft outer surface further than the lead-in zone.

15. The method of claim 14, further comprising forming the press-fit zone such that a fourth distance between the press-fit zone flank surfaces is greater than the second distance such that the press-fit zone flank surfaces are configured to interferingly engage the second flank surfaces when the male and female shafts are subjected to a press-fitting operation.

16. The method of claim 15, further comprising forming a full tooth form zone on the at least one tooth of the plurality of male shaft teeth adjacent to the press-fit zone, wherein the press-fit zone and the full tooth form zone are stepped from each other such that the full tooth form zone extends radially outward from the male shaft outer surface further than press-fit zone.

17. The method of claim 16, further comprising:
forming the full tooth form zone with a forward surface configured to interferingly engage a stop surface of the female shaft splined portion when the male and female shafts are subjected to the press-fitting operation.
